(19) United States
(12) Patent Application Publication
(10) Pub. No.: US 2019/0281789 A1
(43) Pub. Date: Sep. 19, 2019

(54) A DOUBLE-DINER PET BOWL ASSEMBLY AND A METHOD OF FABRICATING THEREOF

(71) Applicant: Ashish PADIA, Delhi (IN)

(72) Inventor: Ashish PADIA, Delhi (IN)

(21) Appl. No.: 15/570,868

(22) PCT Filed: Aug. 9, 2017
(86) PCT No.: PCT/IN2017/050333

§ 371 Date: Oct. 31, 2017

(30) Foreign Application Priority Data
May 15, 2017 (IN) 201711016957

(51) Int. Cl. A01K 5/01; A01K 7/00; B29C 45/14; B21D 22/02; B21D 28/26

(52) U.S. Cl. CPC A01K 5/0135; A01K 7/005; B29L 2031/7132; B21D 22/02; B21D 28/26; B29C 45/14467

(57) ABSTRACT

A double diner pet food bowl assembly may include first and second dog bowls, and a base portion. The base portion may include first and second opposing ends, and a medial portion separating the first and second opposing ends. Each of the first and second opposing ends may define a receptacle configured to respectively receive the first and second dog bowls. The base portion may have an anti-skid feature on a bottom surface of the base portion and extending between the first and second first opposing ends.

### RELATED APPLICATION

This application is based upon prior filed copending international patent application No. PCT/IN2017/050333 filed Aug. 9, 2017, which claims priority to Indian patent application No. 201711016957 filed May 15, 2017, the entire subject matter of these applications is incorporated herein by reference in its entirety.

### TECHNICAL FIELD

The present disclosure relates to the field of pet accessories, and, more particularly, to a pet food bowls and related methods.

### BACKGROUND

There are plenty of patents in the prior art on pet bowls. These products provide plenty of features but unlike present invention. For example, the inventor of present invention has previously been granted a patent on a pet bowl, i.e. U.S. Pat. No. 8,646,413, dated Feb. 11, 2014, titled “Non-skid double-layer pet bowl and a method of fabricating the same”. This invention relates to a non-skid double-layer pet bowl for feeding animals and also provides a method of fabricating the said bowl. The bowl has an anti-skid bottom, so that the bowl does not move when the animal is eating or drinking from it. Another feature of the bowl is that materials, plastic and metal can be detached from each other. The plastic bowl is on the outside and is printed with various prints to make it attractive. Only this outer plastic bowl can be changed by removing it, in case of any damage or to obtain a different pattern. When detached, both the bowls can be used separately also, as double diner, that is one for feeding and the other one for drinking water for animal. The present invention also provides a method of fabricating the non-skid pet bowl. The bowls of the present invention are easy to fabricate, attractive in appearance and cost-effective.

Further reference is made to U.S. Pat. No. 6,860,229, dated Mar. 1, 2005, titled “Ant-proof pet food bowl” by Craft; David Blain. This invention relates to a double level ant-proof pet food bowl includes a top food container having a first recess at a center of a bottom side of a base of the food container; bottom water container having a second recess at a center of an upper side of a base of the water container; and a central post having an upper end inserted into the first recess, and a lower end inserted into the second recess. The top food container resides on top of the central post and above the bottom water container.

Another reference is made to U.S. Pat. No. 9,402,371, dated Aug. 2, 2016, titled “Pet bowl assembly with detachable lid” by Rabideau; Joseph. In this invention, a pet feeding bowl for holding food and water is provided. The pet feeding bowl has a main receptacle for holding food and water that is supported against the ground by a support structure. An auxiliary receptacle is formed by the outer surface of the main receptacle and the support structure, and may also be used for holding food and water. A first lid may be provided to cover the main receptacle, allowing food or liquid to be stored therein during travel or to prevent access to the contents of the main receptacle. A second lid may be provided to cover the auxiliary receptacle, also for the purpose of storing food or liquid. Both the first and second lids may be placed on the bottom of the pet feeding bowl to provide a non-skid, high-friction connection between the pet-feeding bowl and the support surface or ground on which it rests.

Further reference is made to U.S. Pat. No. 8,833,305, dated Sep. 16, 2014, by Macpherson; Holly, titled “Pet feeding assembly and method of use”. This invention provides a cat feeder assembly and method of providing a cat feeder assembly having at least three walls defining a food placement zone with a food container, with each wall having a top end and a bottom end, and a protective awning coupled to the housing structure and having a selectively adjustable height. The protective awning having a leading edge defining a primary height barrier and at least one secondary height barrier, with the secondary height barrier being located between the primary height barrier and the at least two walls. Both height barriers projecting a first and second imaginary plane substantially parallel to each other and defining a keep-out zone directly under the awning and substantially adjacent to the food container. The method further includes selectively adjusting the protective awning to the shoulder area of a cat the user desires to feed from the food placement zone. The cat feeder assembly comprising: a housing structure including at least two walls, each of the at least two walls having a bottom end and a top end; a food placement zone including a food container located between the at least two walls. There is a protective awning coupled to the housing structure and having a selectively adjustable height. The housing structure further includes a roof coupled to the at least two walls.

Another reference is made to U.S. Pat. No. 8,220,413, dated Jul. 17, 2012, by Laro; Tunji, titled “Pet food server”. This pet food server is for dispensing pet food from a recently opened can at preselected intervals of time where the pet food feeder includes a cylindrical member, a sliding panel for holding an unopened can of pet food located within the cylindrical member, and an electric can opener located on a pedestal for lowering the can opener to the top of the can of unopened pet food to cut the lid from the can and then raising the can opener to its initial position. An electro-magnet is attached to the can opener for lifting the lid off the can of pet food as the can opener is raised to its initial position, and the sliding panel is moved with the can of open pet food through an opening in the cylindrical member for a pet to feed.

This invention provides a pet food server for dispensing pet food from a recently opened can at preselected intervals of time comprising: a cylindrical member; a sliding panel for holding an unopened can of pet food located within said cylindrical member; an electric can opener located on a pedestal for lowering the can opener to the top of the can of unopened pet food to cut the lid from the can and then raising the can opener to its initial position; an electro-magnet attached to the can opener for holding a lid of a can of pet food that is cut; and means for moving said sliding panel with said can of open pet food through an opening in said cylindrical member for a pet to feed. In one embodiment, said sliding panel includes two circular depressions for receiving pet food cans of different diameters.

Another reference is made to U.S. Pat. No. 7,198,005, dated Apr. 3, 2007, by Polimeni, Jr.; Ralph, titled “Pet feeder”. This invention provides a pet feeder includes a base and a lid, the base defining a bowl and the lid defining a reservoir. The base and lid are connected by a hinge, such that the lid can be retained in an open position. Solid food or liquid flows from the reservoir, through a valve, into the bowl. In the case of liquid, the supply of liquid in the bowl is continuously replenished due to the flow of liquid, by gravity, into the bowl. In another embodiment, the feeder may include a single base and separate bowls and separate lids, so that the feeder may provide both solid food and liquid simultaneously. When the lid is closed, the pet feeder becomes a compact structure that can be easily stored and transported.

Another reference is made to U.S. Pat. No. 7,124,709, by Greer, dated Oct. 24, 2006, titled “Pet feeding device”. This invention provides a pet feeder having a base with a removable back splash and side walls adapted to abut an interior wall with a baseboard. This pet feeder is comprising: a. a base having a front wall and two side walls, each side wall having a rear edge and a recess formed in the rear edge of each side wall to accommodate a baseboard; b. a feeding surface mounted on the base and having at least one aperture formed therein in a configuration suitable for a feeding bowl; and c. a back splash removably mounted on a back edge of the feeding surface. The feeding surface has at least two apertures.

A further reference is made to U.S. Pat. No. 6,901,880, by Hammer, dated Jun. 7, 2005, titled “Pet food feeder”. This invention provides a pet food feeder, comprising a connecting member coupled to a support rod, a first connecting surface vertically disposed on the connecting member, a second connecting surface vertically disposed on a containing member of a food bin, a pivotal axis and an axial hole respectively disposed on the first and second connecting surfaces respectively, such that the entire pet food feeder passing through the pivotal axis and the axial hole to combine the containing member and the support rod, and a positioning latch on the second connecting surface being extended into a fixing hole on the first connecting surface to fix an angle of elevation for the opening of the food bin. The positioning latch can be extended into other fixing hole to adjust the angle of elevation of the opening of the food bin to collect the food towards the utmost bottom of the food bin and facilitate the feeding of pets.

Another reference is made to U.S. Pat. No. 5,884,582, by Duckworth, dated Mar. 23, 1999, titled “Pet feeder”. This invention provides a pet feeder holding food and/or water dishes for domestic animals. The pet feeder helps to keep pets from scattering their food or splattering their drink out of their dishes, and is especially useful for preventing dogs with floppy ears from getting their ears wet. In the preferred embodiment, the invention has inter-fitting top and bottom parts. The top part has a handle, and two opposite openings. Likewise, the bottom part has a bottom surface, and two opposite openings, which continue and are equal in width with the openings in the top part. Within each opening a dish can be placed, which may contain food or water. Normally, food will be placed in one dish, and water in the other. In an alternative embodiment, there is a hole in the top part to retain a water bottle allowing two different foodstuffs being placed in the dishes. The device prevents the long, floppy ears of certain animals from getting into the bowl. The top part may be lifted off the bottom part, using the handle. In yet another alternative embodiment, the device is a single unitary part, having a handle, a pair of opposing openings, and an optional retainer for a water bottle, or the like.

A further reference is made to U.S. Pat. No. 4,699,089, by Teschke, dated Oct. 13, 1987, titled “Pet feeder”. This invention provides a pet feeder, particularly for pet dogs, including a storage container for storage of food and accessories and a removable feeding table which prevents access by the pet to the storage container when the pet is feeding and which is removable from the storage container only be vertically upward displacement. The feeding table is provided with a plurality of removable food and water bowls and with a splashboard along the rear and sides of the feeding table.

### SUMMARY

Generally, a double diner pet food bowl assembly may include first and second dog bowls, and a base portion. The base portion may include first and second opposing ends, and a medial portion separating the first and second opposing ends. Each of the first and second opposing ends may define a receptacle configured to respectively receive the first and second dog bowls. The base portion may include an anti-skid feature on a bottom surface of the base portion and extending between the first and second first opposing ends.

The base portion may include a peripheral wall extending around the receptacles for the first and second dog bowls and configured to retain spillage from the first and second dog bowls. Each receptacle may include an upper layer abutting the first and second dog bowls.

The upper layer may comprise a plastic resin. The plastic resin may be is selected from polypropylene, acrylonitrile butadiene styrene, low-density polyethylene, high-density polyethylene, crystal, acrylic, and nylon. The base portion may comprise a bonding layer between the upper layer and adjacent portions of the first and second opposing ends. The bonding layer may comprise a thermoplastic elastomer. The thermoplastic elastomer may comprise at least one of rubber, silicone, and a thermoplastic material. The base portion may comprise polypropylene. The anti-skid feature may comprise a plurality of rubber feet extending downward to contact a surface.

One aspect is directed to a method for making a double diner pet food bowl assembly. The method may include forming a base portion comprising first and second opposing ends, and a medial portion separating the first and second opposing ends. Each of the first and second opposing ends may define a receptacle configured to respectively receive first and second dog bowls. The base portion may include an anti-skid feature on a bottom surface of the base portion and extending between the first and second first opposing ends.

Yet another aspect is directed to a method for making a double diner pet food bowl assembly. The double diner pet food bowl assembly may comprise a base portion comprising first and second opposing ends, and a medial portion separating the first and second opposing ends. Each of the first and second opposing ends may define a receptacle configured to respectively receive first and second dog bowls. Each receptacle may include an upper layer abutting the first and second dog bowls. The base portion may include an anti-skid feature on a bottom surface of the base portion and extending between the first and second first opposing ends. The method may include forming the upper layer with an injection molding process, placing the upper layer on a mold for bonding plastic and thermo-elastic rubber together by injection molding to make the upper layer so that material flows, forming the first and second dog bowls, the forming comprising stamping a stainless steel sheet, cutting and trimming edges of a stamped stainless steel piece, rolling the edges to remove any sharpness, and polishing the stamped stainless steel piece using a buffing machine. In some embodiments, the injection molding process comprises a single-step molding.

### BRIEF DESCRIPTION OF THE DRAWINGS

FIG. 1 is a schematic perspective view of a double diner pet food bowl assembly, according to the present invention.

FIG. 2 is a schematic bottom plan view of the double diner pet food bowl assembly of FIG. 1.

FIG. 3 is another schematic perspective view of the double diner pet food bowl assembly of FIG. 1.

FIGS. 4-7 are images of an example embodiment of the double diner pet food bowl assembly, according to the present invention.

### DETAILED DESCRIPTION

However, none of the above discussed inventions provide to a pet bowl, which comprises two parallel bowls kept on a surface which is ant-proof and also acts as a double-diner so that two pets can eat together and/or one bowl can be used for food and the other one for water. The bowls of said product can be safely locked into the provided mat without using any external locking means. Thus, the present invention provides a unique and innovative product, comprising all these features in one product only.

The present invention relates to the field of pet bowls. More particularly, the present invention relates to a double-diner pet bowl assembly. Even more particularly, the present invention provides double-diner pet bowl system in which two separate pet bowls can be locked into one mat or tray type base with proper placing and locking systems for two bowls, so that at a time two pets can have food or one bowl can be used for food and another for water for the pet. The present invention also provides a method of fabricating such double-diner mat and bowls assembly

The primary objective of the invention is to provide a multi-purpose assembly for pets. Another objective of the present invention is to provide a multi-purpose double-diner pet bowl assembly. Another objective of the invention is to provide a double-diner system wherein both the bowls can be safely locked into the base or stand of the feeder so that the bowl does not topple with the normal activity of the animal. Another objective of the invention is to provide a system for double-diner and their base/mat/tray, wherein no screws are required to keep the bowls in place. A further objective of the present invention is to provide a method of fabricating such multi-purpose double-diner mat and bowls assembly.

The present invention relates to an improved double-diner pet bowl assembly. The invention provides double-diner pet bowl system in which two separate pet bowls can be locked into one mat or tray type base with proper placing and locking systems for two bowls, so that at a time two pets can have food or one bowl can be used for food and another for water for the pet. There is also provided a method of fabricating such double-diner mat and bowls assembly.

Accordingly, the present invention provides an improved double-diner multi-purpose mat cum bowl assembly, and a method of fabricating thereof, said assembly comprising a base portion including two holders/receptacles for fixing a bowl removably, said assembly having an anti-skid bottom, said two holders/receptacles separated from each other by a portion in between, and said method of fabrication comprises molding of anti-skid material over bottom of base material from down side towards upside of base using robotic machinery automatically.

It should be noted that the particular description, features, components, construction, mechanism and embodiments set forth in the specification below are merely exemplary of the wide variety and arrangement of instructions which can be employed with the present invention. The present invention may be embodied in other specific forms without departing from the spirit or essential characteristics thereof. All the features disclosed in this specification may be replaced by similar other or alternative features performing similar or same or equivalent purposes. Thus, unless expressly stated otherwise, they all are within the scope of present invention. Various modifications or substitutions are also possible without departing from the scope or spirit of the present invention. Therefore, it is to be understood that this specification has been described by way of the most preferred embodiments and for the purposes of illustration and not limitation.

The present invention provides a multi-purpose double-diner mat and bowls assembly for pets. The present invention provides a food grade and dish-washer safe double-diner feeder system for pets. The present invention is an improved double diner pet dish and a mat, which overcomes the many disadvantages of the prior art pet dishes.

The present invention also provides a method of fabricating such double-diner mat and bowls assembly. The method of fabricating said assembly is different and innovative over methods used in prior art. The present method saves time and cost for fabricating bowl and also uses less material. So this method is highly environment-friendly and cost-effective.

The present invention is a dual purpose, double-diner feeder for pets. This diner is able to hold food and liquid together or can serve food to two pets together. There is provided a base/mat/tray surrounding the receptacle chamber for bowls, which keeps the two-bowls affixed, such that once fixed, they are not easy to remove, especially by normal activity of animal.

The diner of the present invention has two main components. The first component comprises a base/tray/mat area, which comprises receptacles or chambers to hold the bowls in place. The second component is the plurality of bowls, which are easily removable yet very tightly affixed and stable when in place inside the first component.

The two receptacles have sufficient distance in between them on the mat/tray/base, so that there is protective barrier preventing the water or liquid from one bowl spilling into the other bowl containing food. Since the second component, i.e. said bowls can be removed; it is easy to wash these and then resupply without moving the entire dish. The mat is rubber mold to make bowl placed firmly. The base is polypropylene (PP).

The molding of rubber over polypropylene is done in different way than traditional techniques. The rubber enters from the bottom through robotic machinery and automatically reaches the top side (down to up). The steel bowl when affixed into rubber base component does not move and also locks in. This cannot be removed by normal activity of animal. The product also is free of any sound as the steel bowl completely locks into the rubber component.

The resin used for making the mat is TPE (thermo-plastic elastomer) and so the product is anti-skid in nature. Due to novel molding step, two steps are avoided and single step molding is achieved as there is no need for separate top and bottom molding.

In the bottom most side, only the points where rubber is placed, touch the ground. The other portions of the entire diner are above the ground level. So, the food placed in the diner is not infected by ants or other insects. Since the bowl is fixed over the mat, even if while consuming or otherwise, some food or liquid is spilled by the animal, it will not be leaked on the ground, this will be spilled on the mat only. The diner mat or tray is having sufficient size to retain the spilled food to avoid spillage on ground/floor.

The feeder of the present invention comprises at least two pet bowls secured safely in a base or stand by in-build locks so that the bowls stand in place and do not topple or move by normal activity of the pet. The material used for manufacturing the device of present invention is all of good quality and thus there are no harmful chemicals which might leach into the food of the pet. The device is very easy to clean and so hygiene is maintained easily. Any component of the device does not catch rust and so the device is durable and has a long life.

The process used for manufacturing the device is very simple. Double Diner Bone Shape manufacturing steps: plastic Mat is made using plastic resin through plastic injection process with the help of injection molding machine, (plastic resin could be any material i.e. Polypropylene, ABS, LDPE, HDPE, Crystal, Acrylic, Nylon etc.)

After plastic mat is made, the same is placed on the mold for bonding plastic and rubber together, which makes the mat anti-skid. This process is done again through injection molding, so that the elastomeric resin flows on the plastic mat and gets bonded permanently. The elastomer could be any material selected from but not limited to a TPE, TPR, Silicone or rubber.

Once the mat is made, two stainless steel bowls are placed on the mat for serving food or water or to serve two pets together as per the requirement. The process for manufacturing stainless steel bowl is: stainless Steel pet bowl is made by stamping process on Hydraulic or any other stamping machines for stainless steel. After stamping the bowl, the edges of stainless steel bowl are cut and trimmed with the help of cutting and trimming machine for making the outer edge even on all sides.

After making the bowls even-edged, the edges are rolled, so that they are not sharp, to avoid any accidents. Bowl is polished with the help of buffing machine, for giving shiny or matt surface as per the requirement. The mat of the double-diner bowl is above the ground surface and only the corners of the mat are touching the ground. So, the food and water is safe from being infested by ants/insects etc. Thus, the present invention provides many novel and innovative features in one product, which were not covered in any of the prior art so far.

So accordingly, the present invention provides an improved double-diner multi-purpose mat cum bowl assembly, and a method of fabricating thereof, said assembly comprising a base portion including two holders/receptacles for fixing a bowl removably, said assembly having an anti-skid bottom, said two holders/receptacles separated from each other by a portion in between, and said method of fabrication comprises molding of anti-skid material over bottom of base material from down side towards upside of base using robotic machinery automatically.

In an embodiment, said base has extended portion around bowl holders/receptacles to retain/hold any spillage from bowls while in use. In another embodiment, said mat is made of a plastic resin selected from Polypropylene, Acrylonitrile butadiene styrene (ABS), LDPE, HDPE, Crystal, Acrylic and Nylon etc.

In yet another embodiment, said mat is bonded permanently with a thermo-plastic elastomer from the bottom side to make said mat non-skid and to make bowls remain firmly immovable once fixed. In another embodiment, said step of bonding of plastic resin and thermoplastic elastomer is done through injection molding, so that the elastomeric resin flows on the plastic mat from bottom side towards upper side and gets bonded permanently.

In yet another embodiment, said thermo-plastic elastomer is preferably Rubber, Silicon, TPE or TPR. In another embodiment, said base is preferably made of polypropylene (PP). In another embodiment, said process for fabricating said assembly comprises the steps of: fabricating the mat by injection molding process with the help of injection molding machine; placing the mat of step (a) on the mold for bonding plastic and thermo-elastic rubber together by injection molding to make the mat anti-skid so that rubber flows on the mat and gets bonded permanently and final mat comprises holders/receptacles for keeping bowls in place on the upper side; said bowls are made up of stain-less steel and are fabricated in a separate process by stamping on Hydraulic or any other stamping machines for stainless steel, in which after stamping the bowl, the edges of stainless steel bowl are cut and trimmed with the help of cutting and trimming machine for making the outer edge even on all sides; edges are rolled to avoid any sharpness and bowl is polished with buffing machine to obtain final product.

In yet another embodiment, said bowl holders/receptacles keep bowl immovable, when affixed in it so that the bowls do not move by normal activity of animal. In another embodiment, said entire product is free of any sound while in use, as the bowl completely locks into the receptacle/holder.

In another embodiment, said molding of thermoplastic elastomer over polypropylene is done from bottom-side towards up-side using automatic robotic machinery in a single-step molding, thus making the fabrication cost-effective. In yet another embodiment, at the bottom most side, only the points where rubber is placed, touch the ground and mat portion of the is raised above the ground level, thus making the food placed in the diner safe from ants or other insects.

### ADVANTAGES OF THE INVENTION

Easy to handle and clean
Food grade materials

### Rust Proof

No screws required
More durable

### Anti-skid

Safe from ants/insects as bowl is placed above ground level with only rubber corners touching the ground
Spill-free as any food/water spillage by pet falls over the mat and thus ground or any other surface on which diner is placed remains clean.

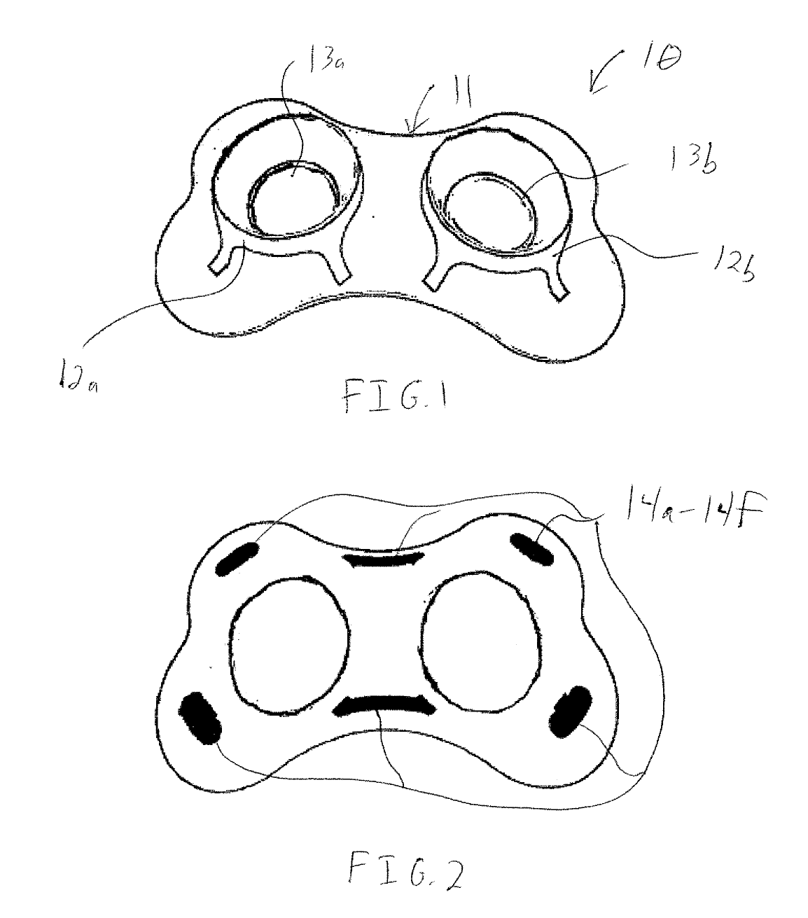

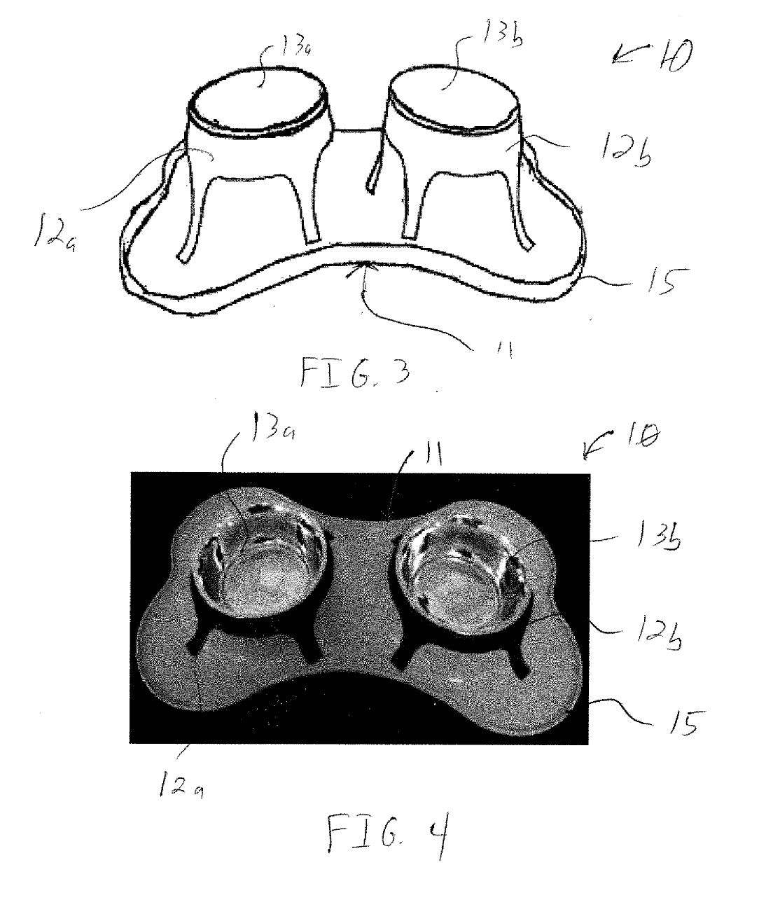

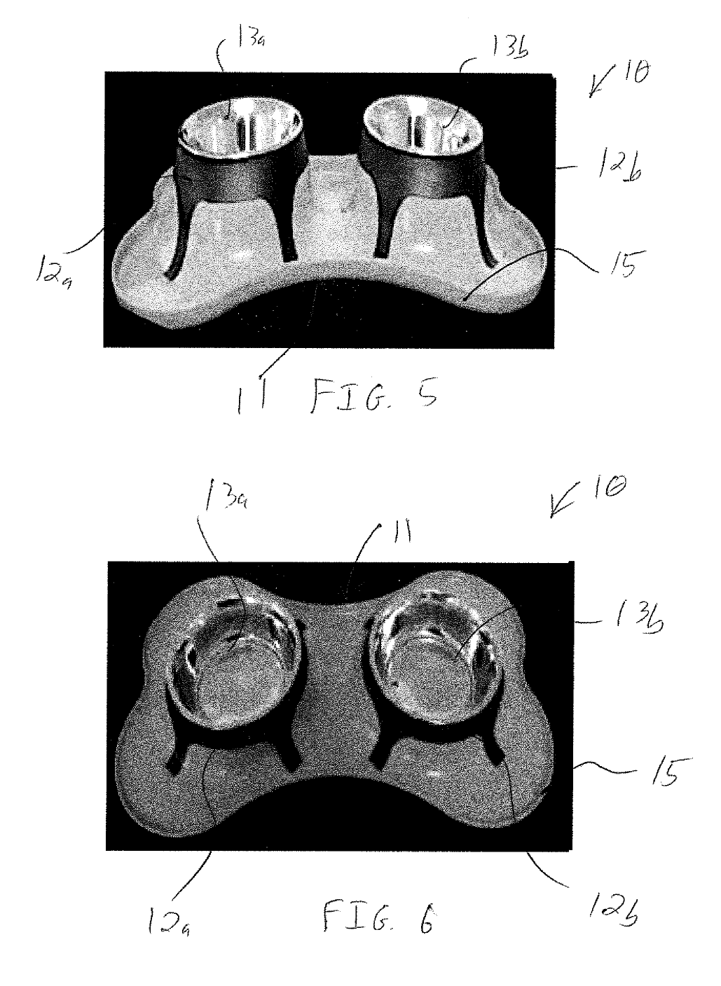

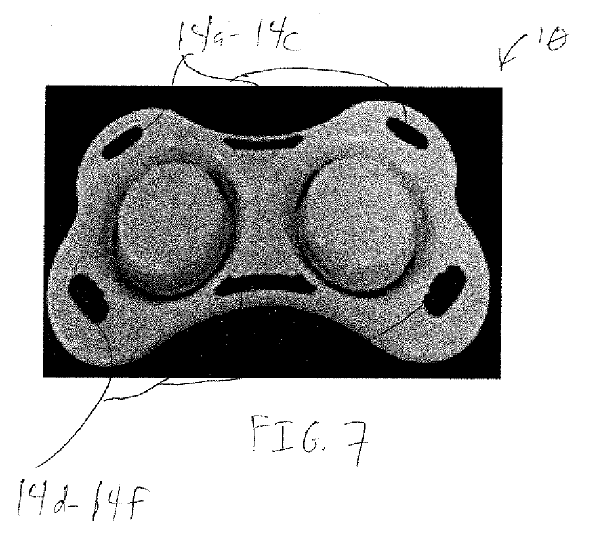

Referring to FIGS. 1-7, a double diner pet food bowl assembly 10 according to the present disclosure in now described. The double diner pet food bowl assembly 10 illustratively includes first and second dog bowls 13a-13b, and a base portion 11. The base portion 11 illustratively includes first and second opposing ends, and a medial portion separating the first and second opposing ends. Each of the first and second opposing ends defines a receptacle configured to respectively receive the first and second dog bowls 13a-13b. The base portion 11 illustratively includes an anti-skid feature 14a-14f on a bottom surface of the base portion and extending between the first and second first opposing ends.

The base portion 11 illustratively includes a peripheral wall 15 extending around the receptacles for the first and second dog bowls 13a-13b and configured to retain spillage from the first and second dog bowls. Each receptacle illustratively includes an upper layer 12a-12b abutting the first and second dog bowls 13a-13b.

The upper layer 12a-12b may comprise a plastic resin. The plastic resin may be is selected from polypropylene, acrylonitrile butadiene styrene, low-density polyethylene, high-density polyethylene, crystal, acrylic, and nylon. The base portion 11 may comprise a bonding layer between the upper layer 12a-12b and adjacent portions of the first and second opposing ends. The bonding layer may comprise a thermoplastic elastomer. The thermoplastic elastomer may comprise at least one of rubber, silicone, and a thermoplastic material. The base portion 11 may comprise polypropylene. The anti-skid feature 14a-14f may comprise a plurality of rubber feet extending downward to contact a surface.

One aspect is directed to a method for making a double diner pet food bowl assembly 10. The method may include forming a base portion 11 comprising first and second opposing ends, and a medial portion separating the first and second opposing ends. Each of the first and second opposing ends may define a receptacle configured to respectively receive first and second dog bowls 13a-13b. The base portion 11 may include an anti-skid feature 14a-14f on a bottom surface of the base portion and extending between the first and second first opposing ends.

Yet another aspect is directed to a method for making a double diner pet food bowl assembly 10. The double diner pet food bowl assembly 10 may comprise a base portion 11 comprising first and second opposing ends, and a medial portion separating the first and second opposing ends. Each of the first and second opposing ends may define a receptacle configured to respectively receive first and second dog bowls 13a-13b. Each receptacle may include an upper layer 12a-12b abutting the first and second dog bowls 13a-13b. The base portion 11 may include an anti-skid feature 14a-14f on a bottom surface of the base portion and extending between the first and second first opposing ends. The method may include forming the upper layer 12a-12b with an injection molding process, placing the upper layer on a mold for bonding plastic and thermo-elastic rubber together by injection molding to make the upper layer so that material flows, forming the first and second dog bowls 13a-13b, the forming comprising stamping a stainless steel sheet, cutting and trimming edges of a stamped stainless steel piece, rolling the edges to remove any sharpness, and polishing the stamped stainless steel piece using a buffing machine. In some embodiments, the injection molding process comprises a single-step molding.

1-13. (canceled)

14. A double diner pet food bowl assembly comprising:
first and second dog bowls; and
a base portion comprising first and second opposing ends, and a medial portion separating said first and second opposing ends;
each of the first and second opposing ends defining a receptacle configured to respectively receive said first and second dog bowls;
said base portion comprising an anti-skid feature on a bottom surface of said base portion and extending between said first and second first opposing ends.

15. The double diner pet food bowl assembly of claim 14 wherein said base portion includes a peripheral wall extending around the receptacles for said first and second dog bowls and configured to retain spillage from said first and second dog bowls.

16. The double diner pet food bowl assembly of claim 14 wherein each receptacle includes an upper layer abutting said first and second dog bowls.

17. The double diner pet food bowl assembly of claim 16 wherein said upper layer comprises a plastic resin.

18. The double diner pet food bowl assembly of claim 17 wherein said plastic resin is selected from polypropylene, acrylonitrile butadiene styrene, low-density polyethylene, high-density polyethylene, crystal, acrylic, and nylon.

19. The double diner pet food bowl assembly of claim 16 wherein said base portion comprises a bonding layer between said upper layer and adjacent portions of said first and second opposing ends.

20. The double diner pet food bowl assembly of claim 19 wherein said bonding layer comprises a thermoplastic elastomer.

21. The double diner pet food bowl assembly of claim 20 wherein said thermoplastic elastomer comprises at least one of rubber, silicone, and a thermoplastic material.

22. The double diner pet food bowl assembly of claim 14 wherein said base portion comprises polypropylene.

23. The double diner pet food bowl assembly of claim 14 wherein said anti-skid feature comprises a plurality of rubber feet extending downward to contact a surface.

24. A method for making a double diner pet food bowl assembly, the method comprising:
forming a base portion comprising first and second opposing ends, and a medial portion separating the first and second opposing ends;
each of the first and second opposing ends defining a receptacle configured to respectively receive first and second dog bowls;
the base portion comprising an anti-skid feature on a bottom surface of the base portion and extending between the first and second first opposing ends.

25. The method of claim 24 wherein the base portion includes a peripheral wall extending around the receptacles for the first and second dog bowls and configured to retain spillage from the first and second dog bowls.

26. The method of claim 24 wherein each receptacle includes an upper layer abutting the first and second dog bowls.

27. The method of claim 26 wherein the upper layer comprises a plastic resin.

28. The method of claim 27 wherein the plastic resin is selected from polypropylene, acrylonitrile butadiene styrene, low-density polyethylene, high-density polyethylene, crystal, acrylic, and nylon.

29. A method for making a double diner pet food bowl assembly having a base portion comprising first and second opposing ends, and a medial portion separating the first and second opposing ends, each of the first and second opposing ends defining a receptacle configured to respectively receive first and second dog bowls, each receptacle including an upper layer abutting the first and second dog bowls, the base portion comprising an anti-skid feature on a bottom surface of the base portion and extending between the first and second first opposing ends, the method comprising:
forming the upper layer with an injection molding process;
placing the upper layer on a mold for bonding plastic and thermo-elastic rubber together by injection molding to make the upper layer so that material flows;
forming the first and second dog bowls, the forming comprising
stamping a stainless steel sheet,
cutting and trimming edges of a stamped stainless steel piece,
rolling the edges to remove any sharpness, and
polishing the stamped stainless steel piece using a buffing machine.

30. The method of claim 29 wherein the injection molding process comprises a single-step molding.

31. The method of claim 29 wherein the base portion includes a peripheral wall extending around the receptacles for the first and second dog bowls and configured to retain spillage from the first and second dog bowls.

32. The method of claim 29 wherein each receptacle includes an upper layer abutting the first and second dog bowls.

33. The method of claim 32 wherein the upper layer comprises a plastic resin.
